(19) United States
(12) Patent Application Publication
(10) Pub. No.: US 2025/0363527 A1
(43) Pub. Date: Nov. 27, 2025

(54) Application for Monetizing Advertisements

(71) Applicant: Eric TURCOTTE, Ile-Bizard (CA)

(72) Inventor: Eric Turcotte, Ile-Bizard (CA)

(21) Appl. No.: 18/867,330

(22) PCT Filed: May 17, 2023
(86) PCT No.: PCT/CA2023/050679

§ 371 Date: Nov. 19, 2024

Related U.S. Application Data
(60) Provisional application No. 63/376,789, filed on Sep. 23, 2022.

(51) Int. Cl. G06Q 30/0273; G06Q 30/0241; G06Q 30/0242; G06Q 30/0251; G06Q 30/0282

(52) U.S. Cl. CPC G06Q 30/0273; G06Q 30/0242; G06Q 30/0271; G06Q 30/0277; G06Q 30/0282

(57) ABSTRACT

A computer-implemented method for monetizing advertisement views in which a processor that is located on a computer initiates the following steps. On a user electronic device, at a proprietary database, receiving one or more advertisements electronically communicated thereto from one or more advertisement sources. The advertisements are electronically communicated to a user/reader based on user/reader profile data collected by an advertisement publicist operably connected to the proprietary database. A preferred advertisement is then selected from the received one or more advertisements and viewed for a predetermined time. The user/reader provides a rating to the selected preferred advertisement after viewing for the predetermined time, and then receives a financial compensation after rating the viewed advertisement.

### TECHNICAL FIELD

The present generally concerns monetizing advertisements, and more particularly monetizing clickable advertisements with a rating system.

### BACKGROUND

Personal electronic devices such as smartphones and tablets have become increasingly popular for both business and recreational use. Businesses have developed numerous ways to advertise their products and/or services using social media platforms in which so-called “pop-up ads” are displayed on the screens while users are watching videos on platforms such as YouTube, Vimeo and the like. However, such pop-up ads are invasive and annoying, and can be blocked or simply ignored. As a result, advertisers lose contact with potential consumers of their products and/or services.

Typically, interested parties click on advertisements when they see a product that aligns with their interest, but they generally receive little in the way of incitement to do so. We have therefore designed a method and a system that provides a financial incentive for viewers who interact with the advertisements. This provides advantages both to the advertiser and to the viewer

To date, the inventor is unaware of a software platform which allows a user to monetize an application displayed by searching in a preferred area.

### BRIEF SUMMARY

We have designed a software application and system for monetizing one or more advertisements, which significantly reduces or essentially eliminates the problems known to plague current online advertisements. To do this, our software allows a user/reader to view an advertisement for a predetermined time and, after providing a rating for the advertisement, receive a financial reward from such interaction. Advantageously, this allows the user/reader to actively engage in the review of advertisements and as such provides feedback to the advertiser via the publicist. The software application can be downloaded to one or more mobile electronic devices, or personal computers, which clearly has the capacity to increase the reach of such a system. Moreover, the amount of information and data provided to the advertiser about their products and/or services is significant. Using our software, advertisers now have access to market data that would otherwise have been expensive to obtain and would require significant human and technical resources to share and analyze.

Accordingly, in one embodiment, there is provided a computer-implemented method for monetizing advertisement views, comprising using a processor located on a computer to initiate the following method steps:
at a proprietary database, receiving one or more advertisements electronically communicated thereto from one or more advertisement sources, the one or more advertisements being electronically communicated to a first user/reader based on first user/reader profile data collected by an advertisement publicist operably connected to the proprietary database;
selecting a preferred advertisement from the received one or more advertisements and viewing the selected, preferred advertisement for a predetermined time;
providing a rating to the selected preferred advertisement after viewing for the predetermined time; and
receiving a financial compensation after rating the viewed advertisement.

In one example, the predetermined time is no less than one second. The predetermined time is up to one minute. The predetermined time is between three to five seconds. The predetermined time is up to three seconds.

In one example, the user/reader rates the selected advertisement using a rating system. The rating system is a star rating system having zero stars, which indicates a lowest rating up to five stars, which indicates a highest rating.

In one example, the advertisement publicist either pushes or suggests the advertisement to the user/reader, or the user/reader selects the advertisement based on predetermined interests from a publicist web portal or a system operator algorithm. The advertisement publicist publishes advertisements for the user/reader targeting the user/reader according to collected profile information and preferences, and in a desired location or region. The user/reader receives compensation for having viewed the advertisement that is aligned with the user/reader's interest. The identity of the user/reader is unknown to the advertisement publicist. The user/reader receives compensation via a bank transfer. The advertisement publicist accesses the system via a web portal. The publicist is in contact with one or more primary advertisers, the primary advertiser monitoring the effectiveness, reach and typical profile of their advertisement by way of one or more dashboards on the website.

In one example, the one or more advertisement sources include first, second and third sources. The first source is a sub-database located in the proprietary database, the sub-database includes advertisers who have stored advertisements, videos and static images on the proprietary database. The second source includes a third-party database connected to the proprietary database, the third-party database. The third source includes pictures of advertisements captured at a physical location, the proprietary database.

Accordingly, in an alternative embodiment, there is provided a system for a computer-implemented method for monetizing advertisement views comprising using a processor located on a computer to initiate the following method steps:
on a first user/reader electronic device, receiving one or more advertisements at a proprietary database electronically communicated thereto from one or more advertisement sources, the one or more advertisements being electronically communicated to a first user/reader based on first user/reader profile data collected by an advertisement publicist operably connected to the proprietary database;
selecting a preferred advertisement from the received one or more advertisements and viewing the selected, preferred advertisement for a predetermined time;
providing a rating to the selected preferred advertisement after viewing for the predetermined time; and
receiving a financial compensation after rating the viewed advertisement.

In one example, the predetermined time is no less than one second. The predetermined time is up to one minute. The predetermined time is between three to five seconds. The predetermined time is up to three seconds.

In one example, the user/reader rates the selected advertisement using a star rating system. The star rating system is zero stars, which indicates the lowest rating up to five stars, which indicates the highest rating.

In one example, the advertisement publicist either pushes or suggests the advertisement to the user/reader, or the user/reader selects the advertisement based on predetermined interests from a publicist web portal or a system operator algorithm. The advertisement publicist publishes advertisements for the user/reader targeting the user/reader according to collected profile information and preferences, and in a desired location or region. The user/reader receives compensation for having viewed the advertisement that is aligned with the user/reader's interest. The identity of the user/reader is unknown to the advertisement publicist. The user/reader receives compensation via a bank transfer. The advertisement publicist accesses the system via a web portal. The publicist is in contact with one or more primary advertisers, the primary advertiser monitoring the effectiveness, reach and typical profile of their advertisement by way of one or more dashboards on the website.

In one example, the one or more advertisement sources include first, second and third sources. The first source is a sub-database located in the proprietary database, the sub-database includes advertisers who have stored advertisements, videos and static images on the proprietary database. The second source includes a third-party database connected to the proprietary database, the third-party database. The third source includes pictures of advertisements captured at a physical location, the proprietary database.

Accordingly, in another alternative embodiment, there is provided with a computer-implemented method for monetizing advertisement views, comprising using a processor located on a computer to initiate the following method steps:
collecting geo-localization coordinates from a location where a user/reader captures an image of an advertisement;
comparing the captured image and the collected geo-localization coordinates with advertisement images stored on a proprietary database, the proprietary database having stored thereon images and coordinates provided thereto by one or more advertisers; and
financially compensating the user/reader when a match is found between the captured image and the collected geo-localization coordinates with the stored advertisement images.

### BRIEF DESCRIPTION OF THE DRAWINGS

These and other features of that described herein will become more apparent from the following description in which reference is made to the appended drawings wherein:

FIG. 1 is a diagrammatic representation of a system in which a proprietary database is in communication with a user/reader computer, wherein the database is located on a proprietary server;

FIG. 1A is a diagrammatic representation of three advertisement sources connected to the proprietary database;

FIG. 2 is a diagrammatic representation of a computer system;

FIG. 3 is a smartphone screenshot showing an account login page;

FIG. 4 is a smartphone screenshot showing a user profile page showing the user location;

FIG. 5 is a smartphone screenshot of an advertisement-type search page;

FIG. 6 is a smartphone screenshot of two advertisements of predetermined product/services;

FIG. 7 is smartphone screenshot of a selected, favorite advertisement;

FIG. 8 is a smartphone screenshot of a rating system for the selected advertisement;

FIG. 9 is a smartphone screenshot of a selected, full screen advertisement with additional rating capability;

FIG. 9A is another smartphone screenshot of a selected, full screen advertisement with additional rating capability;

FIG. 10 is a smartphone screenshot of a My Earnings page showing an amount of financial reward given per advertisement selected and viewed; and

FIG. 11 is a flowchart showing the steps of a process to monetize advertisement view in an embodiment of a computer system.

### DETAILED DESCRIPTION

### Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus, the phrase “consisting of” indicates that the listed elements are required or mandatory and that no other elements may be present.

As used herein, the term “computer” or “computing system' is intended to mean, but not limited to, a hand-held electronic mobile device such as a smartphone, tablet, or a personal computer. Typically, such computers include a screen interface often with touch-screen technology, a cursor and a keyboard, whether separately connected or integral to the screen interface.

As used herein, the term “user/reader” is intended to mean a human user who interacts with the system using a computer described herein.

As used herein, the term “monetization” is intended to mean a reward for example a financial reward such as any type of currency, or a points (or coupon) system wherein the points or coupons are redeemable against a product or a service desired by the user.

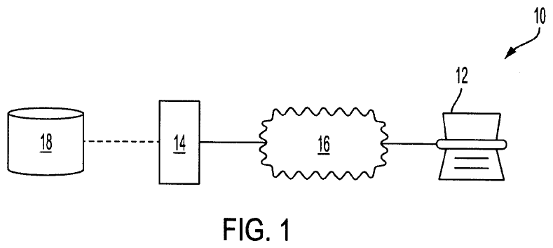

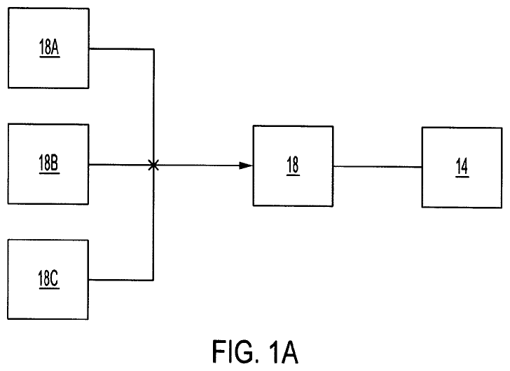

Referring to FIGS. 1 and 1A, broadly speaking, we have designed an environment 10 in which a system and method allows users of computers 12, such as mobile electronic devices, personal computers and the like, to monetize the viewing of advertisements. The system and method are particularly suited for use on mobile electronic devices such as smartphones, tablets and the like, although personal computers are also accessible. The system and method allow an individual user/reader to view one or more selected advertisements by interacting with a computing system (a server) 14 over a network 16. The advertisements which are viewed are either pushed/suggested/sent to the user/viewer from a proprietary database 18, based on pre-defined preferences, or a pre-defined profile, or they are selected by the user/viewer. The database 18 can be accessed by a publicist and stored on the server 18, where it is used independently of the publicist. The advertisement selection can be a random advertisement selection or it can be a focused advertisement selection based on individual preferences or desires. Once selected, the user/viewer can view that advertisement for a predetermined time. After that predetermined time, the user/reader may rate the “likeability” of the advertisement, and then advantageously be financially rewarded thereafter. Generally speaking, the predetermined time varies from not less than three (3) seconds to up to one (1) minute. Of course, the upper end of the time scale can be extended beyond one minute. However, the predetermined time is typically between three (3) to five (5) seconds. During the predetermined time, in one example, the user/viewer must read or view the advertisement within three (3) seconds. This “cutoff” point generally happens at a chosen point during the advertisement. The length of the predetermined time is determined by the nature of the advertisement. Static advertisements generally hold the viewer's attention for longer than a dynamic advertisement. Furthermore, the owner of the server 14 will give the option to the publicist to decide how long the advertisement is to be viewed for. The user/viewer can be exposed to dynamic advertisements such as those viewable using, for example YouTube, or traditional static advertisements, which will require longer viewing times. Generally, the rating system appears at the end of each advertisement, however optionally, the publicist can provide the time point during the advertisement when the rating will appear. Advantageously, this will provide a more random choice. In one example, the rating system employs an easy-to-use a star rating system, which may include zero stars up to seven or more stars. Generally speaking, the upper level of stars will be 5, 6 or 7 stars. A 5-Star system, which is used more often, provides the users/readers with an opportunity to provide immediate feedback, and which when used by the publicist can determine the efficacy of the advertisement. A zero star indicates no interest on the part of the user/reader, whereas a five-star rating indicates the highest interest, with all points in between of one-star to four stars. The rating system is not limited to a star rating system. Indeed, any type of icon, such as a “smiley face” emoji, can be used. This advantageously circumvents the user/viewers from being constantly bombarded with unwanted advertisements, which are invasive and annoying. When enough feedback is collected from the user/viewers, the publicist can then determine whether an advertisement had the desired effect, which generally manifests as an increase in the number of products or services sold, or by increased traffic to the business website. Alternatively, if the advertisement is, for example, a poster, and not a video, then the predetermined time would be zero.

Located on the proprietary server 14, a proprietary database (also referred to as an app advertisement database) 18 is in communication with the computing system 14 via an app interface. Our database 18 is in communication with the “software”. Generally speaking, the advertiser pre-determines how many times he wants the ad to pay and if the same user can view the ad more than once. In one example, an icon would show if the ad is still paying or not, which then causes the reader to move on to another ad. The more a reader participates in the system, the more ads the reader will receive.

Referring now to FIG. 1A, the app advertisement database 18 is fed by three or more possible sources of advertisements. In one source example, a sub-database 18A of the proprietary database 18 is a location where advertisers can store their advertisements. These advertisements include, but are not limited to, videos, and/or static images via the web portal or mobile app. In a second source example, a third-party database 18B is connected to the proprietary database 18. The third-party database 18B can connect their own apps to feed the proprietary database 14. Advantageously, the advertisements do not remain on the proprietary database 14 but are used as a bridge between systems and as media to publish the advertisements on the proprietary database platform.

In the third example, geo-localization coordinates, such as a street, a metro, are collected from a location where a user/reader captures an image of an advertisement. Typically, the user/reader uses a smartphone to capture the image (a photograph or a video clip). The captured image and the collected geo-localization coordinates are compared with advertisement images stored on the proprietary database 18. In examples in which an ad does not allow for geo-localization, Quick Response (QR)-codes may also be used. The proprietary database stores thereon images and coordinates that have been provided by one or more advertisers. When a match is found between the captured image and the collected geo-localization coordinates with the stored advertisement images. The user/reader is financially compensated.

Advantageously, the system and method employed allow businesses to obtain feedback and know which type of advertising is preferred by potential users/buyers of its goods (products) and/or services. The system and method provide individuals or groups with an opportunity to discover and selectively view those advertisements for goods and/or services that are appealing and are within their sphere of interest. Furthermore, our system and method not only help the users/viewers “like” certain businesses, it also helps them discover preferred local businesses in or close to their geographic location. This type of demographic information is very valuable to businesses that may wish to expand their business presence in specific locales.

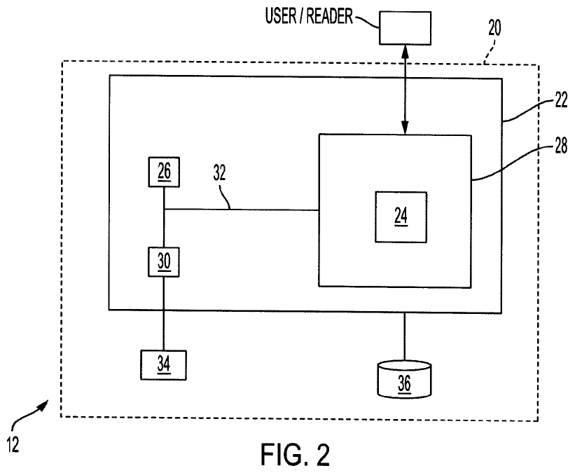

Referring first to FIG. 2, which shows the user/reader computer with a computer infrastructure 20 that can perform the processes described herein. In particular, the computer infrastructure 20 includes a computing device 22 that comprises a management system 24, which makes the computing device 22 operable to perform advertisement monetization according to the method steps described below. The computing device 22 includes a processor 26, a memory 28, an input/output (1/0) interface 30, and a bus 32. Further, the computing device 22 is in communication with an external I/O device/resource 34 and a data storage 36. The data storage 36 includes the purchased publicist advertisement database 18 that is used independently from the publicist.

Generally speaking, the processor 20 executes computer program code, which is stored in the memory 28 and/or the data storage 36. While executing computer program code, the processor 26 can read and/or write data to/from the memory 28, the data storage 56, and/or I/O interface 30. The bus 32 provides a communications link between each of the components in the computing device 22. The I/O device 34 includes a device that permits a user to interact with the computing device 22 or a device that permits the computing device 22 to communicate with one or more other computing devices using any type of communications link known to those skilled in the art. The computing device 22 can be, for example, a personal computer, a server, or a mobile, handheld device, that is capable of executing computer program code installed thereon. In the examples shown herein, the mobile, handheld device is a smartphone such as an iphone, Android and the like.

A person of ordinary skill in the art will readily understand that although a single computer infrastructure 20 is illustrated, two or more computing devices such as a server cluster, that communicate over any type of communications link, such as a network, a shared memory, or the like, can perform the method steps described herein. Furthermore, while performing the process or method steps described herein, one or more computing devices in the computer infrastructure 20 can communicate with one or more additional computing devices that are external to the computer infrastructure 12 using any type of communications link. The communications link includes any combination of wired and/or wireless links; any combination of one or more types of networks, for example, the Internet, a wide area network, a local area network, a virtual private network and the like; and/or utilize any combination of transmission techniques and protocols.

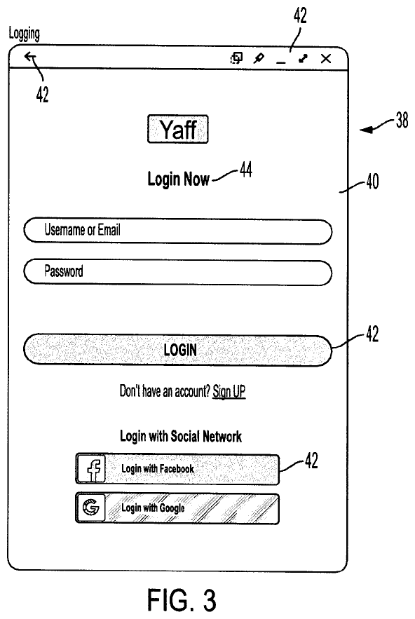

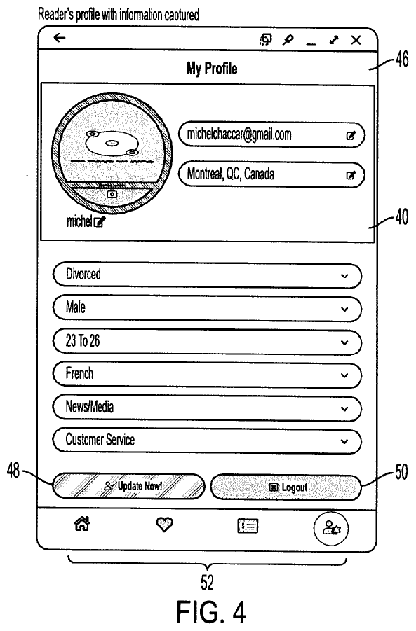

Referring now to FIGS. 3 to 10, a number of screenshots of the advertisement monetization system are illustrated which provides access to information on the system via a smartphone 38. Typically, the smartphone 38 provides a convenient and easy way to stay by which to communicate either by SMS, messaging or telephoning, and grants access to the system by way of Wi-Fi or Bluetooth connection. Typical smartphones include an iphone, Android or a tablet. A display screen 40 includes a plurality of icons 42 that are activated either by touchscreen technology or more conventional keyboards. At the beginning of the process, the user encounters an application which they open by interacting with a Graphical User Interface (GUI) on the display screen 40 on the smartphone 38.

In FIG. 3, the user/viewer begins the process by interacting with a Login Now page 44. The user/viewer enters their username and a password and presses the “LOGIN” button. Alternatively, the user/viewer can access the system via Social Networks which provide access through their portal. Once logged in, the user/viewer can access their profile page 46 (My Profile) which includes a variety of user-specific information, such as, for example, a photo or avatar, location, email address, marital status, gender, age group categories/interests and language. At any time, the user/viewer can update their information using an Update Now button or they may Logout 50. Additional user icons 52 are located at in the lower margin of the display screen 40. Furthermore, one or more additional questions may be asked so as to refine the user profile. Indeed, the more questions the user answers, the more they will receive new advertisements. Advantageously, the more information the user provides, the more advertisements are provided—it incentivizes the user to answer more questions and thus improves their ability to monetize their advertisement views. Also, by when the user provides a rating for the ads viewed, the system collects which type of ads the user prefers and will push those ads, or similar ads, in the future.

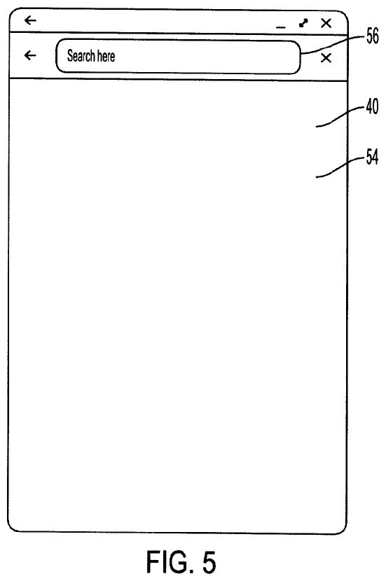

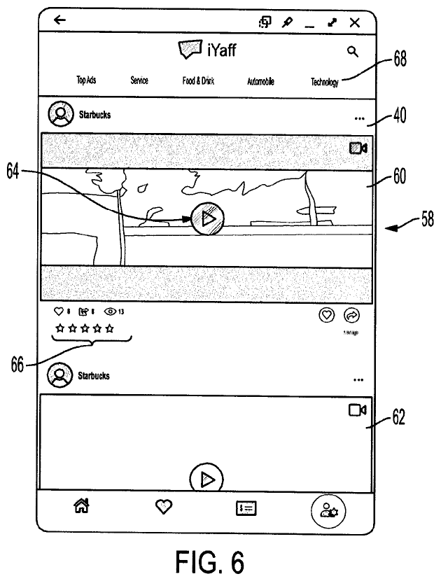

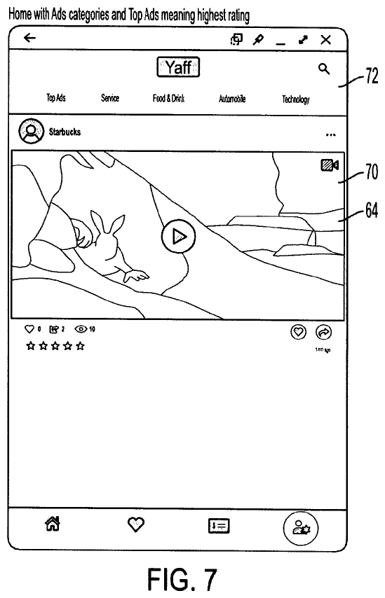

In FIG. 5, the user/viewer can interact with a search page screen 54. A search box 56 located at the top of the display screen 40 allows the user/viewer to type in the desired advertisement subject matter they wish to view. Once, a return or Go button is pressed (not shown), the results are provided, as shown in FIG. 6. FIG. 6 shows a snapshot 58 of a scrolling operation in which a full advertisement 60 is shown at the top part of the display screen 40, and a partial advertisement 62 at the bottom of the display screen 40. The full advertisement 60 provides a Play Icon (a triangle in a white circle) 64 and various icons 66 underneath from other viewers. A row of optional menu items 68 is located at the top part of the display screen 40 that are related to the results of the search. The menu items 68 include for example, Top ads, Service, Food & Drink, Automobile and the like. The user/viewer then has the option of selecting the advertisement for viewing. In the example shown in FIGS. 6 and 7, a selected advertisement 70 can be saved to the Favorites folder and displayed on a Favorites page 72. The user/viewer can then click the Play icon 64 and watch the advertisement 70 for a predetermined time.

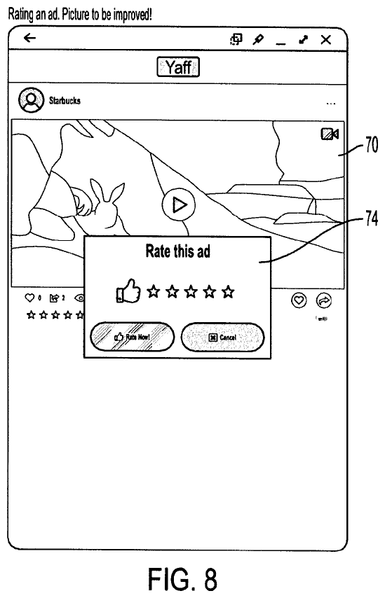

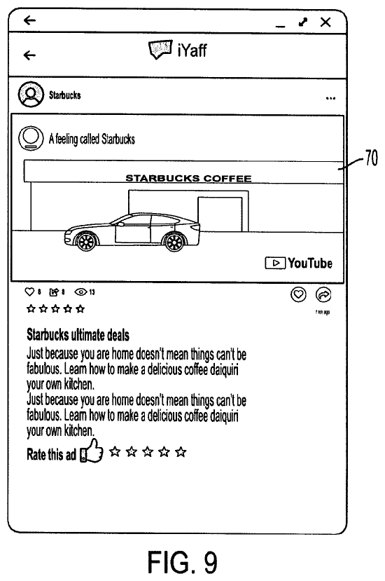

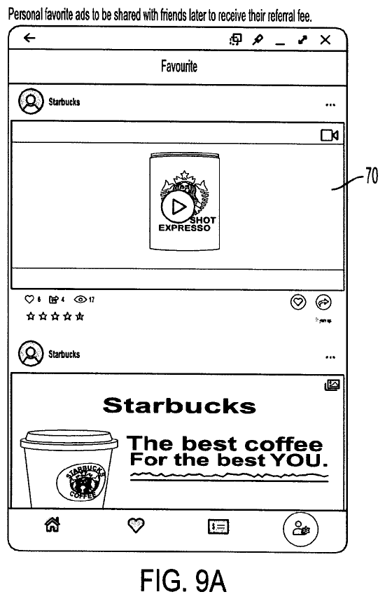

After that, on FIGS. 8, 9 and 9A, the advertisement 70 can be given a rating. A pop-up window entitled Rate this Ad 74 allows the user/viewer to give the viewed advertisement a star rating based on the 5-star rating system. In the example shown, the user/viewer gave the advertisement 70 a 4½ star rating. In an attempt to reduce fraudulent use of the system, the reader has a predetermined time to give the rating, otherwise the reader will be required to check the ad once again. This rating is transmitted to the publicist who then provides a monetary compensation for viewing the advertisement 70 within the pre-determined time. Furthermore, the publicist also decides how many ads he wishes to provide the readers. For example, a multi-level system is possible such as, for example, a first 100 readers, a next 1000 readers, a next 5000 readers and so on, each level including multiple amounts of ads. After the rating is transmitted to the publicist, the publicist pays the system operator and, after reading, the system owner pays the user/reader. The publicist puts a bank of how many readers he wishes to pay. The icons located under each ad include, for example, a Heart (which if clicked sends to Favorites); Sharing (if clicked, to share with friends); Eye (indicates how many times the ad has been seen); and $ (a strikethrough dollar sign means don't pay). Conversely, a dollar sign, with a number adjacent thereto, means pay and how many times to pay are left. The dollar icon is generally located adjacent the Eye.

Still referring to FIG. 9, the system allows the first user to share an ad with one or more friends. If the friend watches the ad, the first user who carried out the initial sharing, is given a reward such as financial compensation.

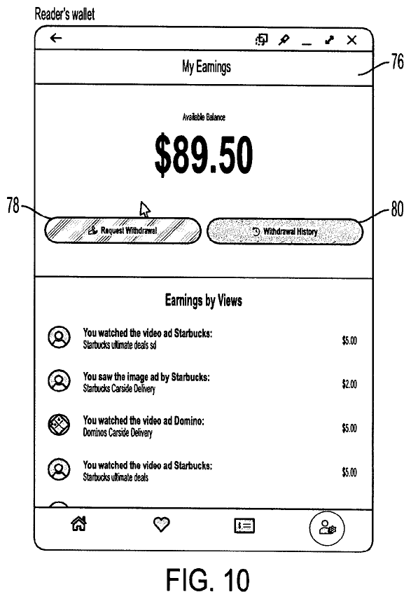

Referring to FIG. 10, the system operator sends the monetary reward to the user/viewer's account where it is displayed on a My Earnings page 76. The user/viewer can then request withdrawal of the amount earned by pressing a “Request withdrawal” button 78. This action transfers the amount earned from the user/viewer account to their financial institution. If desired, the user/viewer can view their withdrawal history by pressing s “Withdrawal history” button 80. Furthermore, additional information can be provided on the My Earnings page 76, such as the relationship between the Earnings by Views, in which for a specific business, the user/viewer can track how much earnings have been made for a specific advertisement from that specific business. In one example, the reader is permitted to withdraw money only if the amount is above a predetermined amount such as, for example $30.

To prevent the user/reader from reviewing the selected advertisement multiple times and collecting multiple payments from the same advertisement, a fail-safe parameter is incorporated into the system. The fail-safe is a parameter that ensures an advertisement that has already been viewed by the user/reader cannot be seen again, unless the publicist sets a parameter of multiple plays with a time interval. The user/reader cannot move the advertisement forward or backward. However, the advertisement can be reviewed as many times as desired, but only after the user/reader has given the rating. The user/reader can replay the ad as many times as is desired. To reiterate this, the user/reader is shown a message indicating that monetization has already occurred. If the advertisement is in a multiple view mode, an icon will be displayed near a heart icon to indicate the interval in order to be paid again. Furthermore, a share icon is provided on the display page screen 40 that indicates that the advertisement can be shared with multiple users. If the user/reader shares the advertisement, the reader/user receives a referral fee. A referral fee is incorporated for influencers who refer the app and to friends of the user/reader who refer the app. There is incorporated though a limited referral fee in time.

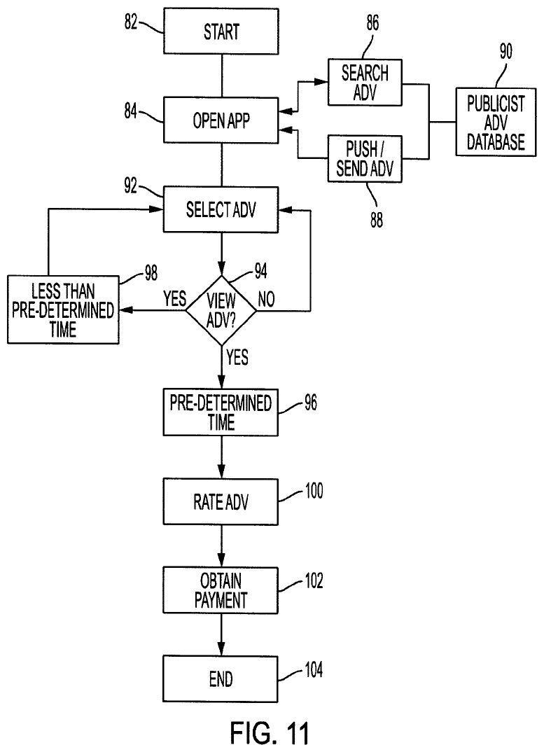

Referring now to FIG. 11, an example of a simplified flow diagram is illustrated to demonstrate the method steps of the system. In very broad terms, the method is useful for a reader/user to monetize the viewing of advertisements. A user/reader starts the process at block 82 which takes them to an option to open the application at block 84. Previously, the user/reader will have entered a list of his/her desires, favorite businesses, services, products and the like together with their location. This is used by the publicist or the system, which determines whether the readers qualify to have ads pushed to them and to permit the publicist to connect a publicist advertisement database at block 90, located on the server 14, with the open app block 84. The user/reader can then search the database 90 via block 86, or have advertisements suggested/pushed to block 84 from block 88. At block 92, the user/reader then selects the advertisement that he/she wishes to view. At block 90 the option of viewing the advertisement is provided. If the user/reader does not wish to view a selected or pushed/suggested advertisement, they can move back to block 92 and select another advertisement. At block 96, the user/reader views the advertisement for a pre-determined time. However, if the user/reader stops viewing before the predetermined time, the system takes the user/reader to block 98 to then re-select another advertisement. At block 100, the user/reader then rates the advertisement using a 5-star rating system. Once this part of the operation is completed, the publicist is notified and at block 102 a payment option is provided. The user/reader at block 104 can then choose to stop the viewing process and eventually logout of the system altogether. The readers also receive notifications to watch a specific ad. The reader may choose to view the ad or ignore it.

In sum, the publicist can publish advertising to the user/reader while targeting the latter according to his profile and preferences, in a desired region or location. The user/reader receives compensation for having viewed an advertisement aligned with his interests and the publicist can segment his audience and understand their needs and profiles. At no time, however, is the name of the user/reader known to the publicist. The reader receives his remuneration via bank transfer. The publicist accesses the system through a web portal. Furthermore, advertisers can monitor the effectiveness, reach and typical profile of their advertisements through dashboards on the website. A person of ordinary skill in the art will recognize that the layout and use of certain functions can be modified according to the needs of the publicist and/or the user/reader.

Alternatively, we have designed a system whereby the publicist can create an advertisement that will appear at the time of a particular event, in a particular location. For Example, during a hockey game at a sporting arena. Indeed, the sponsors of a particular sporting event can be incentivized to “push” an advertisement to all the attendees at the sporting event whose mobile electronic devices have the app downloaded thereon.

Furthermore, our system can be directed toward localized advertising. In this example, the application permits the user/reader to take photographs of the advertisements within his/her visual field, to store them on his account with the GPS coordinates. Thereafter, the publicist will then be able to determine how many people have seen the advertisements and if they wish, they can “push” more publicity to those readers.

Finally, with the advent of advanced social media networks such as TikTok, a series of videos (with advertisements) scroll back and forth so that the user/reader can monetize their experience as they watch the videos along with advertisements. In this case, the publicist chooses a fixed price package or a percentage package to encourage multiple users/readers to watch and monetize the advertisements.

Advantageously, the application and system described herein may also permit geo-localization to:
1—Push advertisements on specific locations such as during an event where the user receives a notification of an advertisement related to his location. This is currently known as “PowerAds”.
2—The user can take a photograph/picture of a physical advertisement which also captures the geographical coordinates. This permits the application and system to track the location and store the photograph/picture on the user's profile so as to obtain monetarized rewards for having seen the advertisement. The system then compares the advertiser's advertisements of that location, the taken photograph/picture and the advertiser's photograph/picture. If there is a match, and if the advertiser is rewarding users to see their advertisements, the advertiser pays the user a predetermined amount of money. In addition, the user can rate the advertisement in order to obtain payment once or after the advertisement is reviewed by the advertiser or based on the system and algorithm used.

In addition to paying readers money to read advertisements, children who are below the local legal age (likely under 18 years old) will be offered points that they can redeem against games, entertainment and the like. Generally speaking, many local laws forbid paying children to read advertisements. To avoid this, our system provides points, which can be accumulated over time, to allow them to use points to pay for entertainment and games.

### Other Embodiments

From the foregoing description, it will be apparent to one of ordinary skill in the art that variations and modifications may be made to the embodiments described herein to adapt it to various usages and conditions.

1-18. (canceled)

19. A system for a computer-implemented method for monetizing advertisement views, the system comprising a processor located on a computer and configured to initiate the following method steps:
on a first user/reader electronic device, receiving one or more advertisements at a proprietary database electronically communicated thereto from one or more advertisement sources, the one or more advertisements being electronically communicated to a first user/reader based on first user/reader profile data collected by an advertisement publicist operably connected to the proprietary database;
selecting a preferred advertisement from the received one or more advertisements and viewing the preferred advertisement for a predetermined time;
providing a rating to the preferred advertisement after viewing for the predetermined time; and
receiving a financial compensation after rating the viewed advertisement.

20. The system, according to claim 19, in which the predetermined time is no less than one second.

21. The system, according to claim 19, in which the predetermined time is up to one minute.

22. The system, according to claim 21, in which the predetermined time is between three to five seconds.

23. The system, according to claim 21, in which the predetermined time is up to three seconds.

24. The system, according to claim 21, in which the first user/reader rates the selected preferred advertisement using a star rating system.

25. The system, according to claim 24, in which the star rating system is zero stars, which indicates the lowest rating, up to five stars, which indicates the highest rating.

26. The system, according to claim 19, in which the advertisement publicist either pushes or suggests the preferred advertisement to the first user/reader, or the first user/reader selects the preferred advertisement based on predetermined interests from a publicist web portal or a system operator algorithm.

27. The system, according to claim 19, in which the advertisement publicist publishes the advertisements for the first user/reader targeting the first user/reader according to collected profile information and preferences, and in a desired location or region.

28. The system, according to claim 19, in which the first user/reader receives the financial compensation for having viewed the preferred advertisement that is aligned with the first user/reader interest.

29. The system, according to claim 19, in which the first user/reader is unknown to the advertisement publicist.

30. The system, according to claim 19, in which the first user/reader receives the financial compensation via a bank transfer.

31. The system, according to claim 19, in which the advertisement publicist accesses the system via a web portal.

32. The system, according to claim 19, in which the advertisement publicist is in contact with one or more primary advertisers, who monitor effectiveness, reach and typical profile of the one or more advertisements by way of one or more website dashboards.

33. The system, according to claim 19, in which the one or more advertisement sources includes first, second and third sources.

34. The system, according to claim 33, in which the first source is a sub-database located in the proprietary database, the sub-database includes advertisers who have stored the advertisements, videos and static images on the proprietary database.

35. The system, according to claim 33, in which the second source includes a third-party database connected to the proprietary database.

36. The system, according to claim 33, in which the third source includes pictures of the advertisements captured at a physical location.

37. A system for a computer-implemented method for monetizing advertisement views, the system comprising a processor located on a computer and configured to initiate the following method steps:
collecting geo-localization coordinates from a location where a user/reader captures an image of an advertisement;
comparing the captured image and the collected geo-localization coordinates with advertisement images stored on a proprietary database, the proprietary database having stored thereon images and coordinates provided thereto by one or more advertisers; and
financially compensating the user/reader when a match is found between the captured image and the collected geo-localization coordinates with the stored advertisement images.

38. The system, according to claim 19, in which the preferred advertisement is a poster, the predetermined time being zero.
